(19) United States
(12) Patent Application Publication
(10) Pub. No.: US 2007/0136232 A1
(43) Pub. Date: Jun. 14, 2007

(54) Displaying tags to provide overall view of computing device activity as recorded within log of records

(76) Inventors: Kazuo Nemoto, Kawasaki-shi (JP); Hiroyasu Ohsaki, Kanagawa-ken (JP)

Correspondence Address: LAW OFFICES OF MICHAEL DRYJA, 704 228TH AVENUE NE, PMB 694, SAMMAMISH, WA, 98074, US

(21) Appl. No.: 11/299,412

(22) Filed: Dec. 12, 2005

(51) Int. Cl. G06F 17/30

(52) U.S. Cl. 707/2

(57) ABSTRACT

Tags are displayed to provide an overall view of computing device activity of a log of records. A bar element is displayed, having sides corresponding to a beginning and an ending time of the log. The tags are displayed within the bar element. Each tag corresponds to a time between the beginning and ending times. The time intervals between the times of immediately successive tags are at least substantially equal. The tags are displayed within the bar element such that they denote relative locations of records that represent computing device activity having occurred at least substantially around the times of the tags. The log of records may be scrolled through within a window, at a speed inversely proportional to spacing between immediately successive tags. The same or different tags may further each graphically represent a time that the computing device activity to which a record corresponds occurred.

### FIELD OF THE INVENTION

The present invention relates generally to logs of records corresponding to computing device activity, and more particularly to displaying tags to provide an overall view of the computing device activity as recorded within such a log of records.

### BACKGROUND OF THE INVENTION

Logs of records are commonly employed within computing devices to record computing device activity. As used herein, a computing device may encompass a number of computing devices, such as a system or a network of such devices. A log of records of computing device activity may be used for statistical purposes, as well as for backup and recovery. Logs of records may be written by an operating system or another computer program for such purposes as recording incoming dialogs, error and status messages, as well as certain transaction details. Start and stop times of routine jobs may further be recorded. As used herein, the type of computing device activity that may be the subject of a log of records is wide-ranging, and not limited by embodiments of the invention, for instance.

In general, a log of records is recorded as follows. When a particular event of computing device activity occurs that should be recorded in the log, a record is written in the log corresponding to the event. The record contains the time at which the particular event occurred, such as including the date of the event, as well as information regarding the event. Many logs are simply text files, where a new record is added to the end of a log by simply writing new text data at the end of the log.

Logs of records regarding computing device activity may be especially useful in failure situations, to determine what caused a given failure. However, they are also useful in assessing the overall performance of a system. Generally, individual records within a log of records are inspected by a user to locate the cause of a failure, or to assess the overall performance of a system. However, inspecting individual records does not provide the user with an overall view of the computing device activity recorded by the log of records. That is, inspecting a log of records can provide a user significant detail regarding the individual events recorded by the records of the log, but attempting to assess the overall view of the computing device activity recorded over the entirety of the log is difficult to accomplish by simply reading through the records of the log.

For this and other reasons, therefore, there is a need for the present invention.

### SUMMARY OF THE INVENTION

The present invention relates in at least some embodiments to displaying tags to provide an overall view of computing device activity as recorded within a log of records. A method of the present invention displays a bar element on a computing device display. The bar element has a first side corresponding to a beginning time of a log of records that corresponds to computing device activity, which is the earliest time of any record within the log. The bar element also has a second side corresponding to an ending time of the log of records, which is the latest time of any record within the log.

Tags are displayed within the bar element. Each tag corresponds to a time between the beginning and ending times. The time intervals between the times of immediately successive tags are at least substantially equal. The tags are displayed within the bar element such that the tags denote relative locations of records within the log of records that represent computing device activity having occurred at least substantially around the times of the tags.

In one embodiment, a window may further be displayed that has a top corresponding to the first side of the bar element and a bottom corresponding to the second side of the bar element. A scroll bar corresponding to the window is displayed to one side of the window, and a portion of the log of records is displayed within the window. A scroll bar element to control the portion of the log of records displayed within the window is displayed at a location within the scroll bar that corresponds to the location of the current portion of the log of records displayed within the window, relative to the log of records as a whole. The location of the scroll bar element within the scroll bar further corresponds to the time of the computing device activity represented by the portion of the log of records displayed within the window, relative to the times to which the tags displayed within the bar element correspond.

In one embodiment, the log of records may be scrolled through within the window, such that a different portion of the log of records is displayed within the window during scrolling. Scrolling occurs at a speed inversely proportional to spacing between immediately successive tags. Thus, immediately successive tags that are spaced closer together results in slower scrolling through the log of records corresponding to computing device activity occurring at times between the times represented by the tags. Similarly, immediately successive tags that are spaced farther apart results in faster scrolling through the log of records corresponding to computing device activity occurring at times between the times represented by the tags.

In another method of the present invention, a window having a scroll bar is displayed on a computing display device. A portion of a log of records corresponding to computing device activity is displayed within the window. A scroll bar element is displayed at a location within the scroll bar that corresponds to a location of the portion of the log of records displayed within the window relative to the log of records as a whole. A bar element is also displayed, and that has a first side corresponding to a top of the window and a second side corresponding to a bottom of the window. For each record of the portion of the log of records displayed within the window, a tag is displayed within the bar element at a location vertically corresponding to a location of the record within the window. The tag further graphically represents a time that the computing device activity to which the record corresponds occurred.

For instance, each tag may include a first bar that has a length and a starting position that together denote a number of hours of the time that the computing device activity to which the record associated with the tag corresponds occurred. Each tag may further include a number of second bars that denote a number of minutes of this time. The first and the second bars may be displayed in different colors, where the second bars are superimposed on the first bar. Each tag may also include a background, in a different color to reflect a change in day of the time.

An article of manufacture of the present invention may include a computer-readable medium and means in the medium. The computer-readable medium may be a recordable data storage medium, a modulated carrier signal, or another type of computer-readable medium. The means is for performing at least some of the parts of the methods of embodiments of the invention that have been described in this summary section, and that are described in the detailed description section below.

Embodiments of the invention provide for advantages over the prior art. By inspecting placement of the tags that have been described within the bar element, a user is able to determine or arrive at a bird's eye view of the computing device activity as recorded within the log of records. That is, an overall view of the computing device activity can be determined by simply viewing the bar element with its tags that are specifically located within the bar element. The tags are arranged such that the time interval between immediately successive tags is at least substantially identical to one another. This means that tags that are physically spaced farther apart represent relatively large amounts of computing device activity having occurred at these times, since there are a relatively large number of records that represent activity having occurred at these times resulting in the tags being placed farther apart. Similarly, tags that are physically spaced closer together represent relatively small amounts of activity having occurred at these times, since there are a relatively smaller number of records that represent activity having occurred at these times resulting in the tags being placed closer together.

Still other aspects, advantages, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram depicting an example log of records and a corresponding bar element having a number of tags, according to an embodiment of the invention.

FIGS. 2, 3, 4, 5, and 6 are diagrams depicting example bar elements having tags and that correspond to different logs of records, according to varying embodiments of the invention.

FIG. 7 is a diagram of a tag that graphically represents time, according to an embodiment of the invention.

FIGS. 8, 9, and 10 are flowcharts of methods, according to varying embodiments of the invention.

FIG. 11 is a diagram of a representative computing device, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

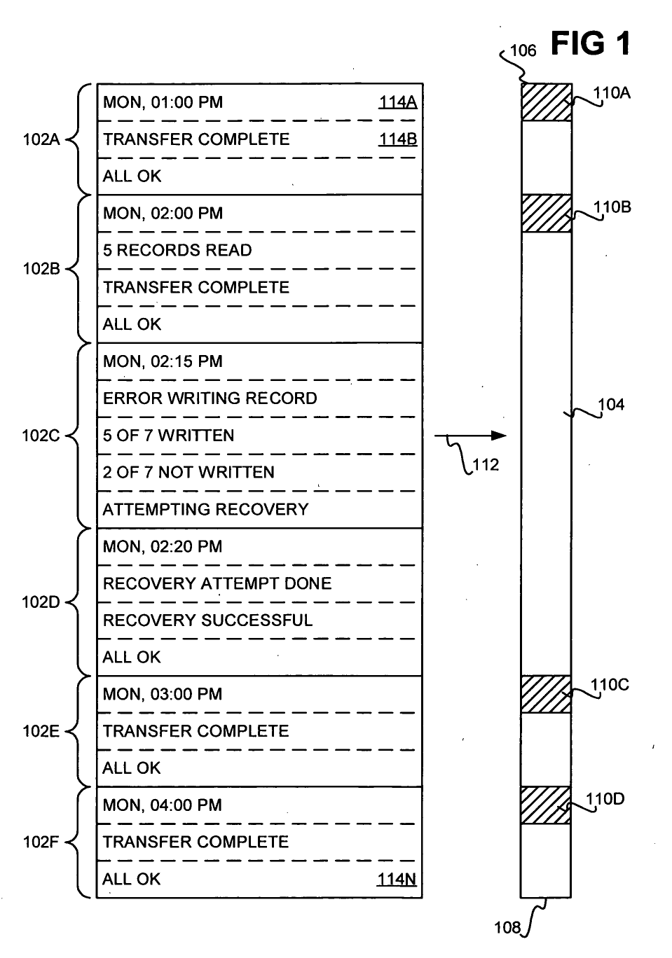

FIG. 1 shows an example and representative log of records 100, in conjunction with which embodiments of the invention may be practiced. The log 100 is depicted as a text file having a number of lines 114A, 114B, . . . , 114N, collectively referred to as the lines 114. The lines 114 of the log 100 are divided into a number of records 102A, 102B, 102C, 102D, 102E, and 102F, collectively referred to as the records 102. The log 100 itself corresponds to computing device activity recorded within the records 102, where each of the records 102 represents a specific event of the computing device activity.

The computing device activity represented by the log of records 100 in the example of FIG. 1 is with respect to disk transfer. Thus, the record 102A specifies that on Monday, at 1:00 PM, transfer was completed, and everything was reported as OK. The record 102A uses three of the lines 114. The record 102B specifies that on Monday, at 2:00 PM, five records were read, transfer was completed, and everything was reported as OK. However, at 2:15 PM on Monday, the record 102C specifies that there was an error writing a record, such that five of seven records were written, and two were not written, such that a recovery attempt was made. At 2:20 PM on Monday, the record 102D denotes that the recovery attempt is finished, and recovery was successful, such that everything is again OK. At 3:00 PM on Monday, the record 102E reports that transfer was completed with everything OK, as does the record 102F on Monday at 4:00 PM.

Each of the records 102 therefore takes up a different number of the lines 114, depending on the amount of information that is reported within the record in question. The first line of a record is the time that the event represented by the record occurred. The time as used herein includes date information as well. It can be seen by reading the log of records 100 in detail that a regular status update is provided every hour, on the hour, via a corresponding record, and that non-regular conditions are further reported by records as needed. For instance, the records 102A, 102B, 102E, and 102F may be considered as regular status update records, whereas the records 102C and 102D may be considered as reporting non-regular conditions, such as an error having occurred and the successful recovery from this error condition.

FIG. 1 further shows a bar element 104 having tags 110A, 110B, 110C, and 110D, collectively referred to as the tags 110, inspection of which provides a bird's eye view of the computing device activity as recorded within the log of records 100, according to an embodiment of the invention. The bar element 104 is displayed on a computing device display. The bar element 104 is a graphical element that is in the shape of a bar, which in FIG. 1 is vertically oriented. The bar element 104 and its tags 110 are generated based on the log 100, as denoted in FIG. 1 by the arrow 112, as is now explained in detail.

The bar element 104 has a first side, or top, 106, and a second side, or bottom, 108. The top 106 can be considered as corresponding to the beginning time of the log of records 100, whereas the bottom 108 can be considered as corresponding to the ending time of the log 100. The beginning time of the log 100 is the time of the earliest record within the log 100, or 1:00 PM on Monday in the example of FIG. 1, whereas the ending time of the log 100 is the time of the latest record within the log 100, or 4:00 PM on Monday in the example of FIG. 1.

The tags 110 each represent different times between the beginning and ending times of the log of records 100, where as used herein this includes the beginning and ending times themselves. Furthermore, the time interval between immediately successive tags is at least substantially equal, and is particularly equal in the example of FIG. 1. Thus, the tag 110A may represent 1:00 PM, the tag 110B may represent 2:00 PM, the tag 110C may represent 3:00 PM, and the tag 110D may represent 4:00 PM, such that all of these times are between the beginning and ending times of the log 100, and the time interval between immediately successive tags is one hour. That is, the time interval between tags 110A and 110B, between tags 110B and 110C, and between tags 110C and 110D is each one hour in length.

The tags 110 are displayed within the bar element 104 such that they denote the relative locations of the records 102 within the log of records 100 that represent computing device activity having occurred at the times of the tags 110. This is explained by particular reference to FIG. 1, where the height of the bar element 104 is equal to the height of the log 100 for example purposes for ease in explanation only. The vertical location of the tag 110A within the bar element 104 corresponds to the vertical location of the record 102A relative to the log 100 itself, because the record 102A records computing device activity that occurred at the time of the tag 110A, 1:00 PM. Likewise, the vertical location of the tag 110B within the bar element 104 corresponds to the vertical location of the record 102B relative to the log of records 100, because the record 102B records computing device activity that occurred at the time of the tag 110B, 2:00 PM.

Similarly, the vertical location of the tag 110C within the bar element 104 corresponds to the vertical location of the record 102E relative to the log 100, since the record 102E records computing device activity that occurred at the time of the tag 102E, 3:00 PM. Finally, the vertical location of the tag 110D within the bar element 104 corresponds to the vertical location of the record 102F relative to the log 100, since the record 102F records computing device activity that occurred at the time of the tag 102F, 4:00 PM. Therefore, the tags 110 are not necessarily displayed in an equally spaced manner within the bar element 104, but rather are displayed such that they denote relative locations of records of the log of records 100 that represent computing device activity having occurred at the times of the tags 110.

Inspection of the bar element 104 provides a bird's eye view of the computing device activity as recorded within the log of records 100, without having to consult the log 100 itself. For instance, the distance between the tags 110A and 1110B and the distance between the tags 110C and 110D are relatively close together, and are substantially equal to one another. Therefore, it can be interpreted that not much computing device activity occurred between the times represented by the tags 110A and 110B (i.e., between 1:00 PM and 2:00 PM), and between the times represented by the tags 110C and 110D (i.e., between 3:00 PM and 4:00 PM). It may be concluded, for example, that the system generating this computing device activity was running in a stable manner during these times, and was not overly loaded.

As another example, the distance between the tags 110B and 110C is relatively far apart. Therefore, it can be interpreted that significant activity occurred between the times represented by the tags 110B and 110C (i.e., between 2:00 PM and 3:00 PM). It may be concluded, for instance, that the system generating this computing device activity was running in an unstable manner, resulting in one or more error conditions, and/or was overly loaded. Thus, the viewer of the graphical bar element 104 knows that the tags 110 represent equal time intervals between immediately successive such tags. The viewer also knows that the tags 110 are located within the bar element 104 such that the tags 110 denote the relative locations of the records 102 within the log of records 100 that represent activity having occurred at the times of the tags 110. Therefore, as a result, the viewer is able to determine, or assess, a bird's eye view of the activity by simply viewing the tags 110 within the element 104.

It is noted that the log of records 100 provided in the example of FIG. 1 does not limit the types of computing device activity that can be recorded by logs of embodiments of the invention, and does not represent the types of logs of records that can be used by embodiments of the invention. For instance, typically a log of records will have more records than just six, and they may record different types of computing activity than disk activity as in the log 100 of FIG. 1. Furthermore, a log of records does not have to be a text file in order to be employed in relation to embodiments of the invention. That is, the log 100 is depicted as in FIG. 1 for illustrative and descriptive convenience and clarity.

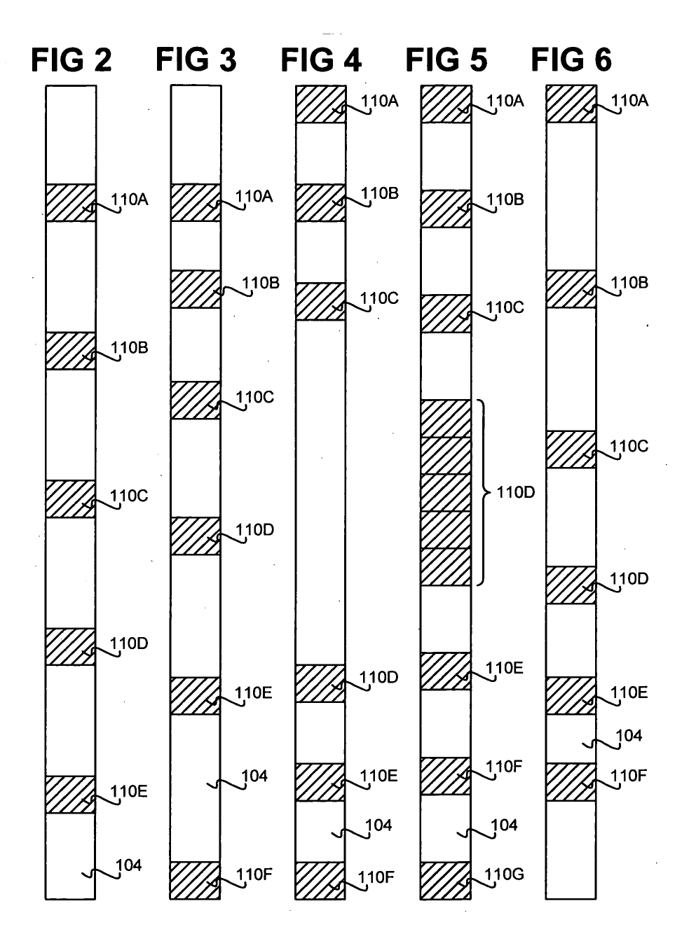

FIGS. 2-6 show the bar element 104 having the tags 110 as reflecting a log of records of different types of computer device activity, according to varying embodiments of the invention. By viewing just the tags 110 of the bar element 104 of these figures, a user is able to discern an overall view, or a bird's eye view, of the computing device activity of the log of records to which the bar element 104 corresponds. Thus, FIGS. 2-6 are provided to show how different types of interpretation can be made in relation to different patterns within the bar element 104.

In FIG. 2, the tags 110 are equally spaced within the bar element 104. That is, the distance between the tags 110A and 110B, the distance between the tags 1110B and 1110C, the distance between the tags 110C and 110D, and the distance between the tags 110D and 110E are all equal or at least substantially equal. As has been described, the time interval between successive tags is equal or at least substantially equal. Therefore, the equal spacing of the tags 110 within the bar element 104 can suggest that the computing device activity of the log of records to which the bar element 104 of FIG. 2 corresponds has occurred at regular intervals, in a stable manner.

In FIG. 3, the tags 110 are gradually spaced farther apart within the bar element 104. Thus, the tags 110 closer to the top of the bar element 104 are closer together than the tags 110 closer to the bottom of the bar element 104. That is, the distance between the tags 110A and 110B is less than the distance between the tags 110B and 110C, which is less than the distance between the tags 110C and 110D, which is less than the distance between the tags 110D and 110E, which is less than the distance between the tags 110E and 110F. The time interval between successive tags is equal or at least substantially equal. Therefore, the gradual farther apart spacing of the tags 110 within the bar element 104 can suggest that the computing device activity of the log of records to which the bar element 104 of FIG. 3 corresponds has increased from the starting time to the ending time of the log. For example, a problem may have occurred in which the computing device or system has an increasingly large load being placed thereon, with which the computing device or system is not able to keep up.

In FIG. 4, the tags 110 are generally equally spaced within the bar element 104, except that there is a large gap in the middle. Thus, the tags 110 are spaced closer together towards the top of the bar element 104, are suddenly spaced farther apart, and then are again spaced closer together towards the bottom of the bar element 104. That is, the distance between the tags 110A and 110B, the distance between the tags 110B and 110C, the distance between the tags 110D and 110E, and the distance between the tags 110E and 110F are equal or at least substantially equal to one another. However, the distance between the tags 110C and 110D is substantially greater than the distance between any two other successive tags. The time interval between successive tags is equal or at least substantially equal. Therefore, the placement of the tags 110 within the bar element 104 can suggest that the computing device activity of the log of records to which the bar element 104 of FIG. 4 corresponds suddenly increased for a period of time between the starting time and the ending time, and specifically between the times represented by the tags 110C and 110D. For example, a problem may have occurred in which the computing device or system had a very large load placed on it for a short period of time, and then the load went back to a more normal level.

In FIG. 5, the tags 110 are generally equally spaced within the bar element 104, except that a number of tags are placed substantially adjacent to one another in the middle. Thus, the tags 110 are equally spaced towards the top of the bar element 104, are suddenly placed immediately together, and then are again spaced equally towards the bottom of the bar element 104. That is, the distance between the tags 110A and 110B, the distance between the tags 110B and 110C, the distance between the tags 110C and 110D, the distance between the tags 110D and 110E, the distance between the tags 110E and 110F, and the distance between the tags 110F and 110G are equal or at least substantially equal to one another. However, the tag 110D is represented as having a number of tags that are placed immediately together or adjacent to one another. In one embodiment, the placement of a number of tags immediately together or adjacent to one another denotes that the computing device activity was stopped for a period of time—such that no logging occurred—and was subsequently restarted later in time. Therefore, in one embodiment, the display of a number of tags in immediate succession within the bar element 104 signifies a relative location of records within the log of records to which the bar element 104 corresponds in which computing device activity stopped and subsequently restarted at a relatively later point in time.

In FIG. 6, the tags 110 are gradually spaced closer together within the bar element 104. Thus, the tags 110 closer to the top of the bar element 104 are farther apart than the tags 110 closer to the bottom of the bar element 104. That is, the distance between the tags 110A and 110B is greater than the distance between the tags 110B and 110C, which is greater than the distance between the tags 110C and 110D, which is greater than the distance between the tags 110D and 110E, which is greater than the distance between the tags 110E and 110F. The time interval between successive tags is equal or at least substantially equal. Therefore, the gradual closer together spacing of the tags 110 within the bar element 104 can suggest that the computing device activity of the log of records to which the bar element 104 of FIG. 6 corresponds has decreased from the starting time to the ending time of the log. For example, a problem may have occurred in which the computing device or system has a decreasingly large load being placed thereon. A data structure may have been deleted that should not have been, for instance, causing the load on the computing device or system to decrease.

In one embodiment, scrolling occurs at a speed that is inversely proportional to spacing between immediately successive tags. Thus, immediately successive tags that are spaced closer together results in slower scrolling through the log of records corresponding to computing device activity occurring at times between the times represented by the tags. Similarly, immediately successive tags that are spaced farther apart results in faster scrolling through the log of records corresponding to computing device activity occurring at times between the times represented by the tags.

This is done so that scrolling is accomplished at a speed proportional to the timing of the various records of the log of records. For example, immediately successive tags that are spaced closer together means that there are fewer records within the log occurring at the times of these tags, such that scrolling is slower to reflect the fact that the time interval between these records is relatively great. By comparison, immediately successive tags that are spaced farther apart means that there are more records within the log occurring at the times of these tags, such that scrolling is faster to reflect the fact that the time interval between these records is relatively small.

Examples of scrolling speeds are now described in relation to the previously describe FIGS. 2-6. In FIG. 2, scrolling occurs at a relatively constant speed, since the tags 110 are relatively equally spaced within the bar element 104. In FIG. 3, scrolling starts at a slower speed and then speeds up to a faster speed, because the tags 110 are gradually spaced farther apart within the bar element 104. In FIG. 4, scrolling starts at a slower speed, speeds up to a much faster speed, and then slows down to the slower speed again, because the tags 110 are relatively equally spaced within the bar element 104, except for a large gap in the middle. In FIG. 5, scrolling starts at a given speed, slows down to a significantly slower speed, and then speeds up to the given speed again, since the tags 110 are relatively equally spaced within the bar element 104, except for a bunching of tags in the middle. In FIG. 6, scrolling starts at a faster speed and then slows down to a slower speed, because the tags 110 are gradually spaced closer together within the bar element 104.

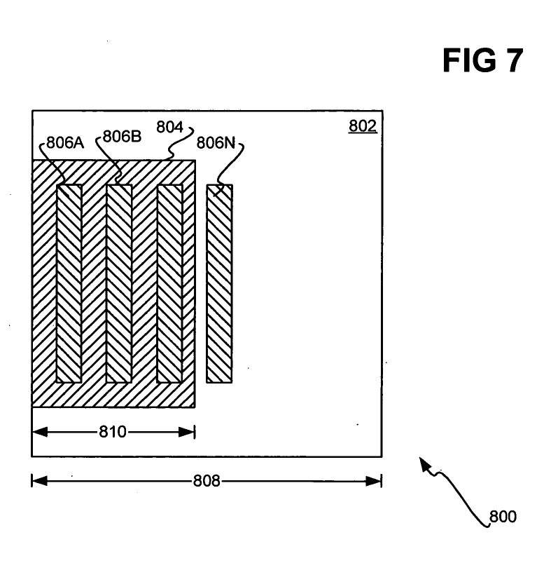

FIG. 7 shows an example tag 800 that graphically represents time, and that can implement any of the tags 110 and 716 where such tags are intended to graphically represent time as has been described, according to an embodiment of the invention. The tag 800 has a background 802. When the date (i.e., the day) changes between an immediately preceding tag and the tag 800, the background 802 can change from white to black, and then from black to white, and so on. Thus, if there are five tags displayed in succession, and the first three tags relate to Monday and the last two tags relate to Tuesday, the first three tags may have a black background and the last two tags may have a white background, or the first three tags may have a white background and the last two tags may have a black background.

The tag 800 also has a first bar 804. The first bar 804 has a length 810 and a starting position that together denote a number of hours of the time represented by the tag 800. For example, if the tag 800 starts at the left side of the background 802 and extends to the right, as in the example of FIG. 7, then the number of hours represented by the tag 800 is between zero and twelve, whereas if the tag 800 starts at the right side of the background 802 and extends to the left, then the number of hours represented by the tag 800 is between twelve and twenty-four. In this way, all twenty-four hours of a given day can be represented by the first bar 804.

More specifically, the first bar 804 has a length 810 that corresponds to the number of hours between zero and twelve or between twelve and twenty-four. The length 810 relative to the length 808 of the background 802 denotes the specific number of hours. If the length 810 is one-twelfth of the length 808, then the first bar 804 represents one hour (i.e., 1:00 AM) where the starting position is at the left side of the background 802, and thirteen hours (i.e., 1:00 PM) where the starting position is at the right side of the background 802. As another example, if the length 810 is five-twelfths of the length 808, then the first bar 804 represents five hours (i.e., 5:00 AM) where the starting position is at the left side of the background 802, and seventeen hours (i.e., 5:00 PM) where the starting position is at the left side of the background 802.

In general, where the length 810 is X-twelfths of the length 808, then the first bar 804 represents X hours where the starting position is at the left side of the background 802, and twelve+X hours where the starting position is at the right side of the background 802. Where the first bar 804 is not displayed at all, then this corresponds to the time of the tag 800 being zero hours, or 12:00 AM (i.e., twelve midnight). If the first bar 804 has a length 810 that is equal to the length 808 of the background 802, then this corresponds to the time of the tag 800 being twelve hours, or 12:00 PM (i.e., twelve noon).

The tag 800 also has a number of second bars 806A, 806B, . . . , 806N, collectively referred to as the second bars 806. The number of the second bars 806 denotes a number of minutes of the time represented by the tag 800. For example, at most there may be able to be displayed twelve of the bars 806 within the length 808 of the tag 800. In such instance, each actually displayed of the bars 806 represents five minutes. In the example of FIG. 7, then, because four bars 806 are displayed, this means that the time represented by the tag 800 is four times five, or twenty, minutes. (It should be appreciated that as is specifically depicted in FIG. 7, twelve bars 806 are likely not be able to be displayed within the length 808 of the background 802, however.) If there are no bars displayed, then this corresponds to zero minutes. In general, where a maximum number of Y bars 806 can be displayed within the length 808 of the background 802, and where there are in actuality X bars displayed, then this corresponds to the time of the tag 800 as having X divided Y times sixty minutes.

Thus, the background 802 of the tag 800 denotes whether or not there has been a day or date change in the time represented by the tag 800 as compared to the tag immediately preceding the tag 800. The starting position and the length of the bar 804 denotes the number of hours of the time. The number of the bars 806 denotes the number of minutes of the time. Furthermore, the bars 806 can be superimposed on the bar 804, as is shown in the example of FIG. 7. The bars 806 may in such instance be a different color than the bar 804, where the former may be red and the latter may be blue, for example.

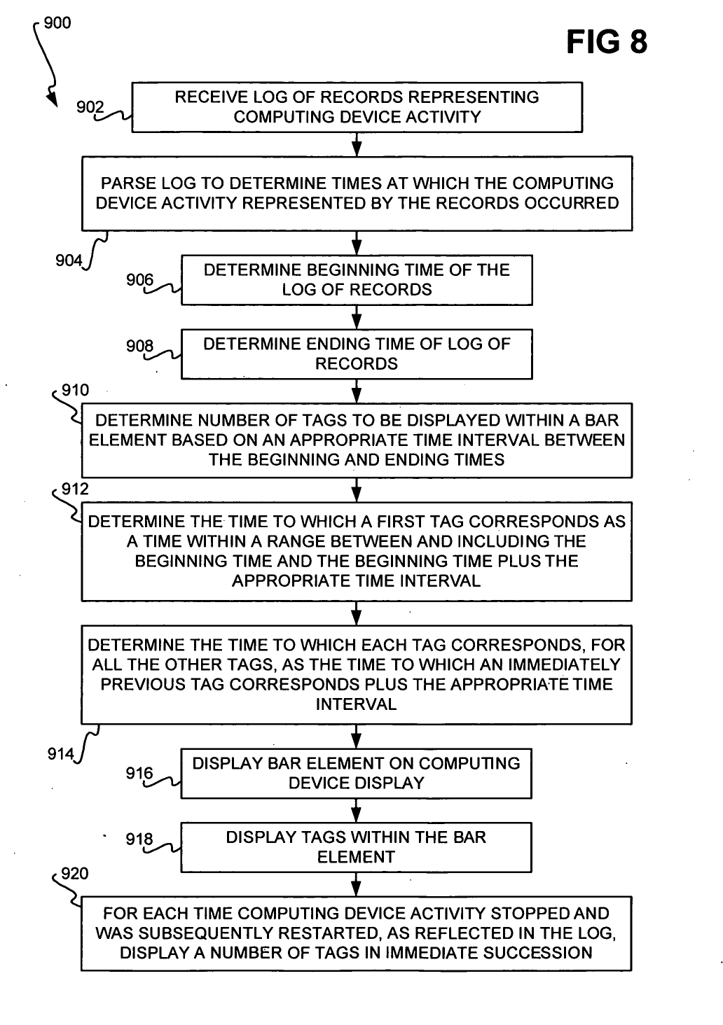

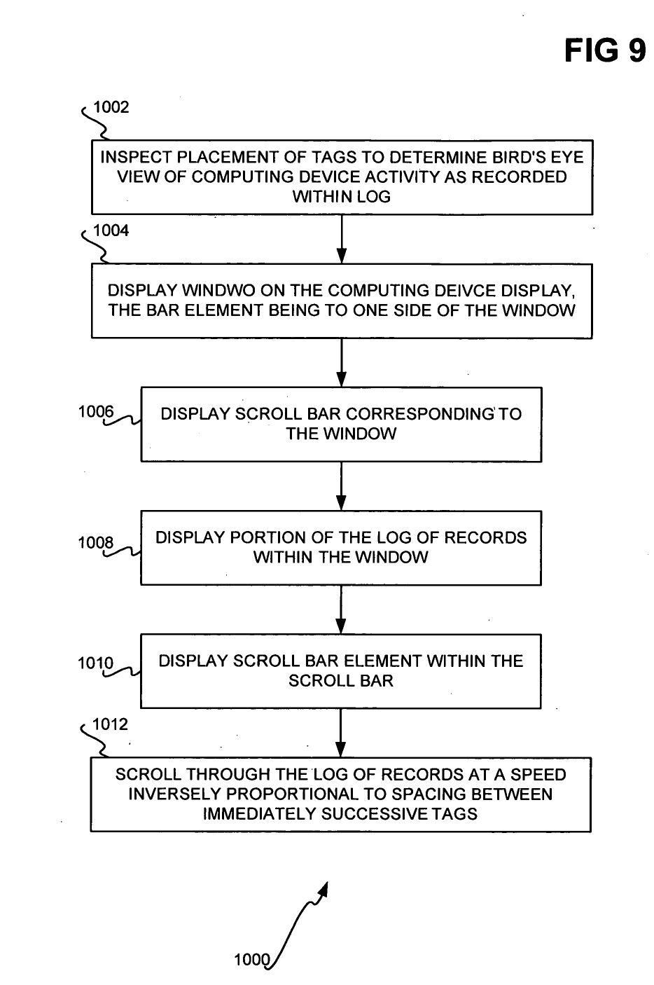

FIGS. 8, 9, and 10 show methods 900, 1000, and 1100, respectively, according to varying embodiments of the invention. The methods 900, 1000, and 1100 may be performed separately, or together as one single method. Parts of the method 900, 1000, and 1100 may furthermore be interchanged with one another. For instance, parts of the method 1000 and 1100 may be added to the method 900, and so on.

Referring first to FIG. 8, a log of records that represents computing device activity is received (902). The log is parsed to determine the times at which the specific events of the computing device activity, as represented by the various records of the log, have occurred (904). The beginning time of the log of records is determined as the earliest time of any of the times of the records (906). That is, the beginning time of the log is determined as the earliest time recorded by one of the records. The ending time of the log of records is determined as the latest time of any of the times of the records (908). That is, the ending time of the log is determined as the latest time recorded by one of the records.

Next, a number of tags to be displayed within a bar element on a computing device display is determined, based on an appropriate time interval between the beginning and ending times (910). Thus, the difference between the beginning and ending times may be twelve hours, such that an appropriate time interval may be determined or selected, such as by the user, as one hour. In such an embodiment, twelve tags would then be displayed. As another example, the difference between the beginning and ending times may be one hour, such that an appropriate time interval may be determined or selected, such as by the user, as six minutes, so that ten tags are displayed.

The number of tags to be displayed may further be determined based on other factors, such as the absolute height, in pixels or another unit of measure, of the bar element to be displayed on the computing device display. For instance, a relatively large bar element may allow for more tags to be displayed than a relatively small bar element. In such an embodiment, once the number of tags has been determined, the time interval is then determined therefrom. For example, it may be determined that ten tags should be displayed. If the difference between the beginning and ending times is ten hours, then the time interval may be determined as one hour.

Next, the time to which a first tag corresponds is determined as a time within a range between and including the beginning time and the beginning time plus the appropriate time interval (912). For example, the time interval may be one hour. If the starting time of the log of records is 9:15 AM, then the first tag may correspond to a time between 9:15 AM and 10:15 AM. For instance, an appropriately selected or determined time of the first tag may be 10:00 AM. Thereafter, the time to which each other tag is determined as the time to which the immediately previously tag corresponds, plus the appropriate time interval (914). Continuing with the example, if the first tag has a time of 10:00 AM, and the time interval is one hour, then the second, third, and fourth tags, for instance, may have times of 11:00 AM, 12:00 PM, and 1:00 PM, respectively.

The bar element is then displayed on the computing device display (916). The bar element has a first side corresponding to the beginning time of the log of records, and a second side corresponding to the ending time of the log of records. The tags are then displayed within the bar element (918). As has been described, each tag corresponds to a time between the beginning and ending times. The tags are displayed within the bar element such that the tags denote relative locations of records within the log that represent computing device activity having occurred at the times of the tags.

That is, the tags are spaced along the bar element as corresponding to how the records themselves populate the log. Where two successive tags represent times between which relatively few records occur within the log (that is, relatively few records representing computing device activity that occurred between these times), then the tags are spaced relatively close together. Where two successive tags represent times between which a large number of records occur within the log (that is, a large number of records representing computing device activity that occurred between these times), then the tags are spaced relatively far apart.

In one embodiment, for each time computing device activity stopped and was subsequently restarted, as reflected in the log of records, a number of tags are displayed in immediate succession (920). Thus, these tags denote a relative location of the records within the log that represent stopping and subsequent restarting of computing device activity. Such a situation has been shown in and described in relation to FIG. 5, for instance. Furthermore, in one embodiment, the tags may each graphically represent the time to which the tag corresponds, as has been described.

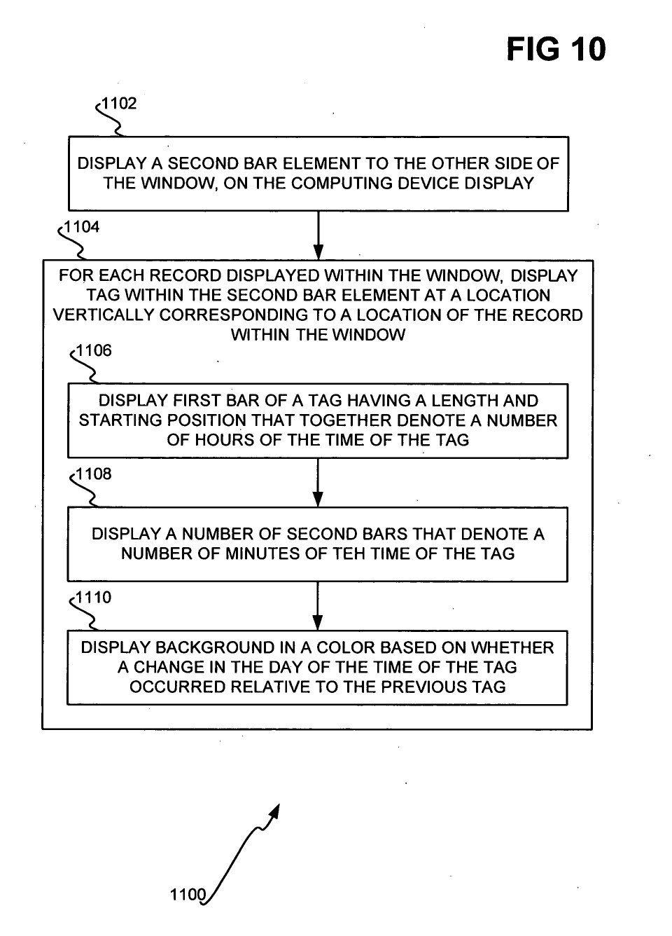

Referring next to FIG. 10, the placement of the tags within the bar element can be inspected to determine at least a bird's eye view of the computing device activity as recorded within the log of records (1002). For example, as has been described in relation to FIG. 2, if it is determined that the tags are equally spaced within the bar element, then it can be concluded in response that the computing device activity occurred at regular intervals in a stable manner. As has been described in relation to FIG. 3, if it is determined that the tags are spaced closer together towards the first side of the bar element and gradually are spaced farther apart, then it can be concluded in response that the computing device activity increased from the starting time to the ending time.

Furthermore, as has been described in relation to FIG. 4, if it is determined that the tags are spaced close together towards the first side of the bar element, suddenly are spaced farther apart, and then are again spaced closer together, it can be concluded in response that the computing device activity suddenly increased for a period of time. As has been described in relation to FIG. 5, if it is determined that a number of tags are placed substantially adjacent to one another at a location within the bar element, then it can be concluded in response that the computing device activity stopped for a period of time and then restarted. Finally, as has been described in relation to FIG. 6, if it is determined that the tags are spaced farther apart towards the first side of the bar element and gradually are spaced closer together, then it can be concluded in response that the computing device activity decreased from the starting time to the ending time.

Still referring to FIG. 10, a window may further be displayed on the computing device display, where the bar element is on one side of the window (1004). A scroll bar corresponding to the window is displayed (1006), and a portion of the log of records is displayed within the window (1008). A scroll bar element is displayed within the scroll bar (1010), at a location corresponding to the location of the portion of the log of records displayed within the window relative to the log of records as a whole. Finally, the log of records may be scrolled through, at a speed inversely proportional to the spacing between immediately successive tags (1012), as has been described.

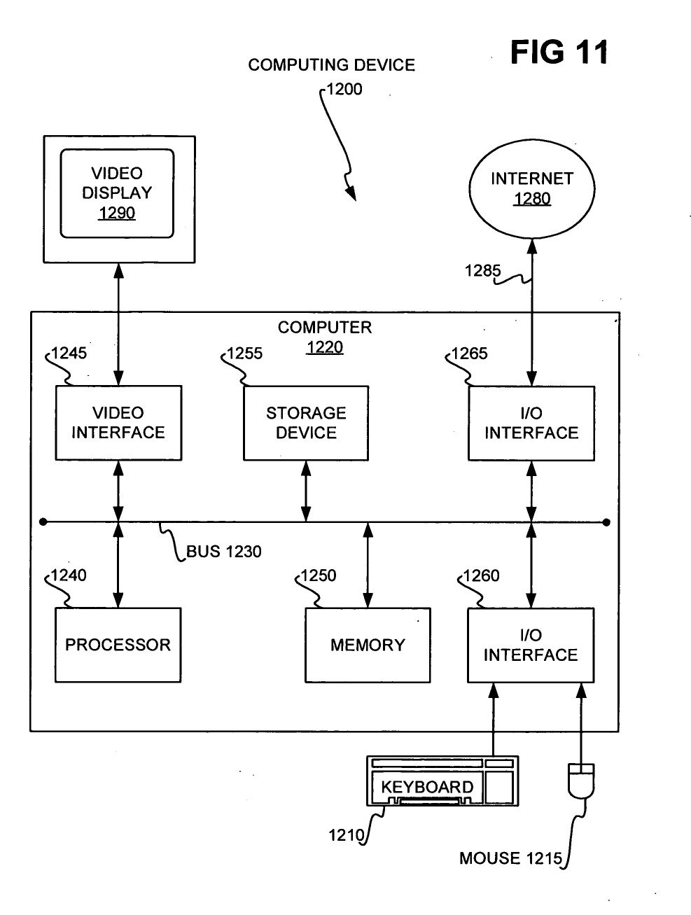

Referring finally to FIG. 11, a second bar element may also be displayed on the computing device display (1102). The second bar element has a first side corresponding to the top of the window that has been displayed on the computing device display, and a second side corresponding to the bottom of the window. Next, for each record displayed within the window—that is, for each record of the portion of the log of records displayed within the window—a tag is displayed within the second bar element (1104). The tag for a record is specifically displayed within the second bar element at a location vertically corresponding to the location of the record within the window.

In one embodiment, each of the tags displayed within the second bar element graphically represent a time that the computing device activity to which a record corresponds occurred. That is, each tag is associated with a record. The time graphically represented by each tag is thus the time that the computing device activity of the record occurred. Such a time may be an absolute time, or a relative time relative to the occurrence of the computing device activity of the immediately preceding record, as has been described.

In one embodiment, the graphical representation of a time by a tag is accomplished as has been described in relation to FIG. 7. Therefore, for instance, a first bar is displayed that has a length and a starting position that together denote a number of hours of the time of the tag (1106). Next, a number of second bars are displayed that denote a number of minutes of the time of the tag (1108). Finally, the background of the tag is displayed in a color based on whether there has been a change in the day of the time of the tag relative to the time of the immediately preceding tag (1110), as has been described.

Finally, FIG. 11 is a schematic representation of a computing device 1200 of a type suitable for implementing the display of a bar element and tags as has been described, according to an embodiment of the invention. Computer software executes under a suitable operating system installed on the computing device 1200 to assist in performing the described techniques. This computer software is programmed using any suitable computer programming language.

The components of the computing device 1200 include a computer 1220, a keyboard 1210 and a mouse 1215, and a video display 1290. The computer 1220 includes a processor 1240, a memory 1250, input/output (I/O) interfaces 1260, 1265, a video interface 1245, and a storage device 1255. The processor 1240 is a central processing unit (CPU) that executes the operating system and the computer software executing under the operating system. The memory 1250 includes random access memory (RAM) and read-only memory (ROM), and is used under direction of the processor 1240.

The video interface 1245 is connected to the video display 1290 and provides video signals for display on the video display 1290. The video display 1290 may also be referred to as a computing device display. User input to operate the computer 1220 is provided from the keyboard 1210 and mouse 1215. The storage device 1255 can include a disk drive or any other suitable storage medium. Each of the components of the computer 1220 is connected to an internal bus 1230 that includes data, address, and control buses, to allow components of the computer 1220 to communicate with each other via the bus 1230. The computing device 1200 can be connected to one or more other similar computers via an input/output (I/O) interface 1265 using a communication channel 1285 to a network, represented as the Internet 1280.

The computer software may be recorded on a portable storage medium, in which case, the computer software program is accessed by the computing device 1200 from the storage device 1255. Alternatively, the computer software can be accessed directly from the Internet 1280 by the computer 1220. In either case, a user can interact with the computing device 1200 using the keyboard 1210 and mouse 1215 to operate the programmed computer software executing on the computer 1220. Other configurations or types of computer systems can be equally well used to perform computational aspects of embodiments of the invention. The computing device 1200 described above is described only as an example of a particular type of system suitable for implementing the described techniques.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A method comprising:
displaying a bar element on a computing device display, the bar element having a first side corresponding to a beginning time of a log of records corresponding to computing device activity, and a second side corresponding to an ending time of the log of records; and,
displaying a plurality of tags within the bar element, each tag corresponding to a time between the beginning and ending times, time intervals between the times of immediately successive tags being at least substantially equal, the tags displayed within the bar element such that the tags denote relative locations of records within the log of records that represent computing device activity having occurred at least substantially around the times of the tags.

2. The method of claim 1, further comprising, for each of a number of times corresponding to the computing device activity having been stopped and then subsequently restarted, displaying a number of tags in immediate succession within the bar element, such that the number of tags denote a relative location of records within the log of records in which computing device activity stopped and subsequently restarted.

3. The method of claim 1, further comprising inspecting placement of the tags within the bar element to determine a bird's eye view of the computing device activity as recorded within the log of records.

4. The method of claim 3, wherein inspecting placement of the tags within the bar element comprises determining that the tags are equally spaced within the bar element, and concluding in response that the computing device activity occurred at regular intervals in a stable manner.

5. The method of claim 3, wherein inspecting placement of the tags within the bar element comprises determining that the tags are spaced closer together towards the first side of the bar element and gradually are spaced farther apart towards the second side of the bar element, and concluding in response that the computing device activity increased from the starting time to the ending time.

6. The method of claim 3, wherein inspecting placement of the tags within the bar element comprises determining that the tags are spaced closer together towards the first side of the bar element, suddenly are spaced farther apart, and then are again spaced closer together towards the second side of the bar element, and concluding in response that the computing device activity suddenly increased for a period of time between the starting time and the ending time.

7. The method of claim 3, wherein inspecting placement of the tags within the bar element comprises determining that a number of tags are placed substantially adjacent to one another at a location within the bar element, and concluding in response that the computing device activity stopped for a period of time and then restarted.

8. The method of claim 3, wherein inspecting placement of the tags within the bar element comprises determining that the tags are spaced farther apart towards the first side of the bar element and gradually are spaced closer together towards the second side of the bar element, and concluding in response that the computing device activity decreased from the starting time to the ending time.

9. The method of claim 1, further comprising:
receiving the log of records;
parsing the log of records to determine times at which the computing device activity represented by the records have occurred;
determining the beginning time of the log of records as an earliest time of any of the times of the records;
determining the ending time of the log of records as a latest time of any of the times of the records;
determining a number of the tags to be displayed within the bar element based on an appropriate time interval between the beginning time and the ending time;
determining the time to which a first tag corresponds as a time within a range between and including the beginning time and the beginning time plus the appropriate time interval; and,
determining the time to which each tag corresponds, for all the tags except a first tag, as the time to which an immediately previous tag corresponds plus the appropriate time interval.

10. The method of claim 1, further comprising:
displaying a window having a top corresponding to the first side of the bar element and a bottom corresponding to the second side of the bar element, on the computing display device;
displaying a scroll bar corresponding to the window to a side of the window;
displaying a portion of the log of records within the window; and,
displaying a scroll bar element at a location within the scroll bar that corresponds to a location of the portion of the log of records displayed within the window relative to the log of records as a whole,
wherein the location of the scroll bar element within the scroll bar further corresponds to a time of computing device activity represented by the portion of the log of records displayed within the window, relative to the times to which the tags displayed within the bar element correspond.

11. The method of claim 10, further comprising scrolling through the log of records within the window, such that a different portion of the log of records is displayed within the window during scrolling,
wherein scrolling occurs at a speed inversely proportional to spacing between immediately successive tags, such that immediately successive tags that are spaced closer together results in slower scrolling through the log of records corresponding to computing device activity occurring at times between the times represented by the tags, and such that immediately successive tags that are spaced farther apart results in faster scrolling through the log of records corresponding to computing device activity occurring at times between the times represented by the tags.

12. The method of claim 10, wherein displaying the tags within the bar element comprises displaying each tag as graphically representing the time to which the tag corresponds.

13. A method comprising:
displaying a window on a computing display device, the window having a scroll bar;
displaying a portion of a log of records within the window, the log of records corresponding to computing device activity;
displaying a scroll bar element at a location within the scroll bar that corresponds to a location of the portion of the log of records displayed within the window relative to the log of records as a whole;
displaying a bar element having a first side corresponding to a top of the window and a second side corresponding to a bottom of the window; and,
for each record of the portion of the log of records displayed within the window,
displaying a tag within the bar element at a location vertically corresponding to a location of the record within the window, and as graphically representing a time that the computing device activity to which the record corresponds occurred.

14. The method of claim 13, wherein displaying the tag as graphically representing the time that the computing device activity to which the record corresponds occurred comprises displaying the tag as graphically representing the time that the computing device activity to which the record corresponds occurred relative to a time that the computing device activity to which an immediately previous record corresponds occurred.

15. The method of claim 13, wherein displaying the tag as graphically representing the time that the computing device activity to which the record corresponds occurred comprises displaying the tag as graphically representing an absolute time that the computing device activity to which the record corresponds occurred.

16. The method of claim 13, wherein displaying the tag as graphically representing the time that the computing device activity to which the record corresponds occurred comprises:
displaying a first bar having a length and a starting position that together denote a number of hours of the time; and,
displaying a number of second bars that denote a number of minutes of the time.

17. The method of claim 16, wherein the first bar and the second bars are displayed in different colors, and the second bars are displayed as superimposed on the first bar.

18. The method of claim 13, wherein displaying the tag as graphically representing the time that the computing device activity to which the record corresponds occurred comprises displaying a background in a different color to reflect a change in day of the time.

19. The method of claim 13, wherein displaying the tag comprises displaying a number of other tags as the tag, to denote that a relatively long length of time has passed in arriving at the time graphically represented by the tag.

20. An article of manufacture comprising:
a computer-readable medium; and,
means in the medium for:
displaying a bar element on a computing device display, the bar element having a first side corresponding to a beginning time of a log of records corresponding to computing device activity, and a second side corresponding to an ending time of the log of records;
displaying a plurality of tags within the bar element, each tag corresponding to a time between the beginning and ending times, the tags displayed within the bar element such that the tags denote relative locations of records within the log of records that represent computing device activity having occurred at the times of the tags;
displaying a window having a top corresponding to the first side of the bar element and a bottom corresponding to the second side of the bar element;
displaying a scroll bar corresponding to the window to a side of the window;
displaying a portion of the log of records within the window;
displaying a scroll bar element at a location within the scroll bar that corresponds to a location of the portion of the log of records displayed within the window relative to the log of records as a whole, the location of the scroll bar element within the scroll bar further corresponding to a time of computing device activity represented by the portion of the log of records displayed within the window, relative to the times to which the tags displayed within the bar element correspond;
displaying a second bar element having a first side corresponding to a top of the window and a second side corresponding to a bottom of the window; and,
for each record of the portion of the log of records displayed within the window, displaying a tag within the second bar element at a location vertically corresponding to a location of the record within the window, as graphically representing a time that the computing device activity to which the record corresponds occurred.
